(19) United States
(12) Patent Application Publication
(10) Pub. No.: US 2010/0138929 A1
(43) Pub. Date: Jun. 3, 2010

(54) CONDITIONALLY TRACEABLE ANONYMOUS SERVICE SYSTEM

(75) Inventors: Seung Wan HAN, Gwangju (KR); Sok Joon LEE, Daejeon (KR); Yun Kyung LEE, Daejeon (KR); Sin Hyo KIM, Daejeon (KR); Jeong Nyeo KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/622,222

(22) Filed: Nov. 19, 2009

(30) Foreign Application Priority Data
Dec. 2, 2008 (KR) 10-2008-0121395
Mar. 23, 2009 (KR) 10-2009-0024569

(51) Int. Cl. G06F 21/00

(52) U.S. Cl. 726/26

(57) ABSTRACT

Conditionally traceable anonymous service system is provided. The system respectively separates subject conforming real name, subject conforming anonymity, subject requesting verification for an anonymity certification means, so that privacy of a user is hardly violated, the present invention can acquire real name information for the user only when a trace for a user is surely requested.

### CROSS-REFERENCE TO RELATED APPLICATION

This application claims priority from Korean Patent Application No. 10-2008-0121395 filed on Dec. 2, 2008 and Korean Patent Application No. 10-2009-0024569 filed on Mar. 23, 2009 in the Korean Intellectual Property Office, the disclosure of which is incorporated herein by reference in its entirety.

### BACKGROUND OF THE INVENTION

1. Field of the Invention

The present invention relates to a conditionally traceable anonymous service system, and more particularly, to a conditionally traceable anonymous service system, in which a domain performing a real name certification and a domain performing an anonymity certification are separated, so that an identity of user writing bulletin board is not disclosed and the system can trace a user only when a user writes an illegal bulletin.

2. Description of the Related Art

Conventionally, when a user writes on an on-line bulletin, the user only disclosures his or her ID. Although the user only disclosures his or her ID, the user provides personal information to a web service server when the user sign up in order to login to the web service server. Therefore the web service server can always grasp personal information of the user.

In other words, a conventional anonymity means anonymizes only among the users of the web service server.

In a case when the web service server knows personal information of the users, the identity of the user writing illegal bulletin is grasped. Thus the user writing the bulletin illegally may be immediately controlled. However the web service server does not guarantee the security of personal information of the users being illegally distributed, especially in a current situation when the personal information of a user is easily being disclosed on the internet.

Accordingly a present invention protects thoroughly real name information of a user, which is personal information of a user, by selectively grasping personal information of the user only when the user writes an illegal bulletin.

### SUMMARY OF THE INVENTION

The present invention provides a conditionally traceable anonymous service system, which can minimize disclosure of personal information of a user by selectively tracing a user only when the user writes on the bulletin illegally. The present invention provides a conditionally traceable anonymous service system, in which the user writes on the bulletin through an anonymity certification means. The user may also use various services provided from a web service server through the anonymity certification means.

According to the present invention, there is provided a conditionally traceable anonymous service system, the system including a real name process server generating a real name certification means for a user; an anonymity process server generating a anonymity certification means corresponding to the real name certification means; and a trace server requesting a real name certification for the anonymity certification means to the anonymity process server when a web service server requests a real name certification for the anonymity certification means; wherein the anonymity process server certifies the anonymity certification means when the trace server requests the real name certification for the anonymity certification means and provides the certified anonymity certification means to the real name process server, and wherein the real name process server performs a real name certification for the certified anonymity certification means, so that an authority for anonymity confirmation, real name confirmation, and trace request is separated.

Accordingly, the present invention respectively separates subjects confirming real name, subjects confirming anonymity, subjects requesting verification for an anonymity certification means from each other. Hence the privacy of a user is hardly violated. Also the present invention provides method for the system to acquire real name information of the user only when a trace for a user is necessary.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a diagram of a conditionally traceable anonymous service system according to an aspect of the present invention;

FIG. 2 illustrates a block diagram for an exemplary embodiment of a real name process server illustrated at FIG. 1;

FIG. 3 illustrates a block diagram for an exemplary embodiment of an anonymity process server illustrated at FIG. 1;

FIG. 4 illustrates a block diagram for an exemplary embodiment of a trace server illustrated at FIG. 1;

FIG. 5 illustrates a block diagram for an exemplary embodiment of a web service server illustrated at FIG. 1.

### DETAILED DESCRIPTION OF THE INVENTION

The present invention will hereinafter be described in detail with reference to the accompanying drawings in which exemplary embodiments of the invention are shown.

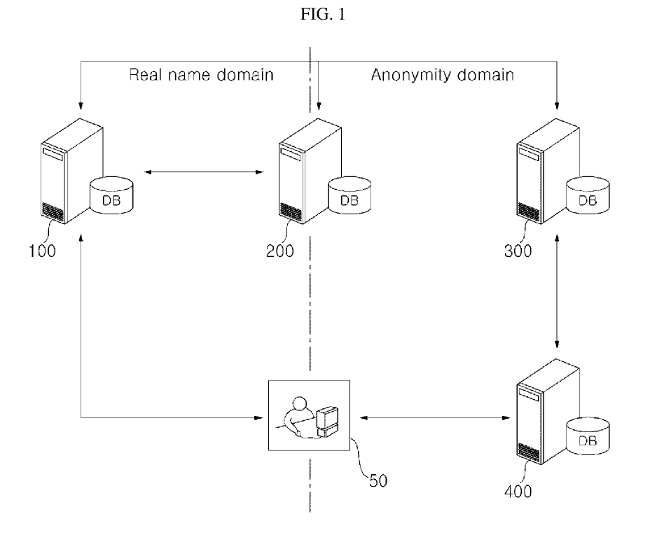

FIG. 1 illustrates a diagram of a conditionally traceable anonymous service system according to the present invention.

Referring to FIG. 1, the system includes a real name process server 100, an anonymity process server 200, and a trace server 300.

In the present invention, the real name process server 100, the anonymity process server 200, and the trace server 300 are separated from each other. The authority of the servers 100, 200 and 300 is also clearly separated. The real name process server 100, the anonymity process server 200, and the trace server 300 are implemented on different servers and belongs to different managing subjects. Hence the disclosure of personal information of a user or privacy violation by one server could be prevented.

In the present invention, the real name process server 100 issues a real name certification means to a user according to a request from the user. The anonymity process server 200 issues an anonymity certification means corresponding to the real name certification means. The trace server 300 transmits the anonymity certification means for the user, whom the web service server 400 requests the real name certification, to the anonymity process server 200 and requests a real name certification. The user does not need to provide personal information to the web service server 400.

The user may accesses the web service server 400 using the anonymity certification means acquired by the anonymity process server 200 and write on the web service server 400. The user may also use various services provided by the web service server 400. Therefore, the web service server 400 does not know any personal information of the user directly. Also the web service server 400 does not store any personal information of the user.

The web service server 400 transmits an anonymity certification means provided by the user, which is provided by the user to use services provided by the web service server 400, to the anonymity process server 200. The anonymity process server 200 determines the validity of the anonymity certification means transmitted by the web service server 400, and transmits the result of the validity determination to the web service server 400. The web service server 400 may permit service use of the user according to the result of validity determination of the anonymity process server 200.

The anonymity certification means which the user provides to the web service server 400 through a terminal 50 does not include information which may be used to directly analogize the user. Currently, the anonymity certification means may be an anonymity certificate or a group key. The real name certification means may be a real name certificate or OTP (one time password). However when a certification means for anonymity certification or real name certification for the user is suggested later, the scope of the present invention may encompass the suggested real name certification means or anonymity certification means.

The real name certification means according to the present invention does not include a conventional certification means based on ID and password. When a conventional certification means based on ID and password is used, a web service server may know personal information of a user since the user has to provide personal information to the web service server as the user signs up for the web service provided by the web server.

In the present invention, the real name process server 100 performs a real certification and generates a real name certification means. After the anonymity process server 200 generates an anonymity certification means using the real name certification means generated by the real name process server 100. Therefore, an anonymity certification means of the user may be uses as a real name certification means. However the anonymity certification means does not have any personal information of the user.

The user may access the web service server 400 using the anonymity certification means and use various services provided by the web service server 400, such as writing on a bulletin, or reading from the bulletin.

Therefore, when the web service server 400 needs a real name certification for the user writing a bulletin illegally, the web service server 400 provides an anonymity certification means of the user to the trace server 300 and requests a real name certification for the user to the trace server 300.

The trace server 300 may acquire the anonymity certification means of the user requested by the web service server 400, and transmits the acquired anonymity certification means to the anonymity process server 200.

The anonymity process server 200 determines validity for the anonymity certification means transmitted by the trace server 300. When the result of determination is valid, the anonymity process server 200 transmits the anonymity certification means to the real name process server 100. The real name process server 100 looks up a real name certification means corresponding to the anonymity certification means transmitted by the anonymity process server 200, and grasps identity of the user through the looked up real certification means. The grasped identity of a user is may be transmitted to the according order; the real name process server 100, the anonymity process server 200, the trace server 300, and the web service server 400. Or it may be transmitted to the according order; the real name process server 100, the anonymity process server 200, and the web service server 400. However the transmitted order may vary and the identity of the user may be provided through various other paths.

Therefore, according to the present invention, the user may write the bulletin or uses the web service using the anonymity certification means of the user, in which case the identity of the user is not disclosed. Moreover, the real name process server 100, the anonymity process server 200 and the trace server 300 are respectively separated from each other and are managed independently, so that the identity of the user cannot be inquired indiscriminately.

Currently available anonymity certification means may be anonymity certificate, or group member key. However, any type of certification means, which does not disclose the personal information of a user, may be one of the anonymity certification means.

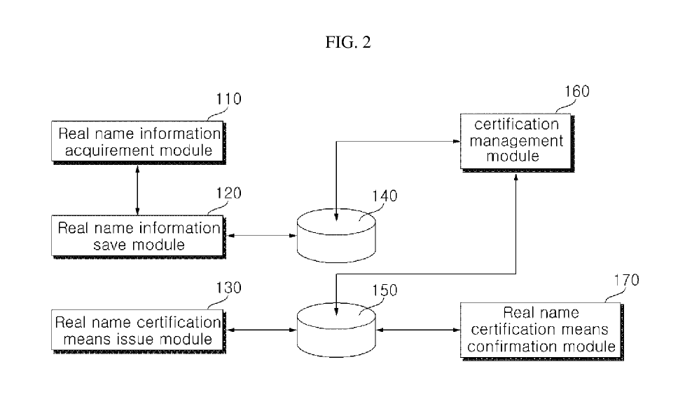

FIG. 2 illustrates a block diagram for an exemplary embodiment of a real name process server illustrated at FIG. 1.

Referring to FIG. 2, the real name process server 100 according to the exemplary embodiment includes a real name information acquirement module 110, a real name information save module 120, a real name certification means issue module 130, a real name information database 140, and a real name certification means issue database 150.

The real name information acquirement module 110 acquires personal information of a user though the terminal 50. To acquire the personal information of the user, the real name information acquirement module 110 provides interface with a security function to the terminal 50, and may acquire personal information corresponding to real name information from the terminal 50. The real name information save module 120 may save the personal information of the user acquired by the real name information acquirement module 110 in the real name information database 140.

The real name certification means issue module 130 issues a real name certification means based on real name information (or, personal information) provided by the user though a terminal 50 to the user. Also, the real name certification means issue module 130 saves the real name certification means generated corresponding to the user in the real name information database 140.

A certification management module 160 manages the data saved in the real name information database 140 and the real name certification means issue database 150. The certification management module 160 may provide interface and program which the manager of the real name process server 100 may use to access the real name information database 140 and the real name certification means issue database 150, if necessary.

When the real name information for an anonymity certification means is requested by the anonymity process server 200, the real name certification means confirmation module 170 looks up the real name certification means corresponding to the anonymity certification means. The real name certification means confirmation module 170 provides the real name certification means or real information (personal information) of the user which is requested by the anonymity process server 200 based on a real name certification means which have been looked up.

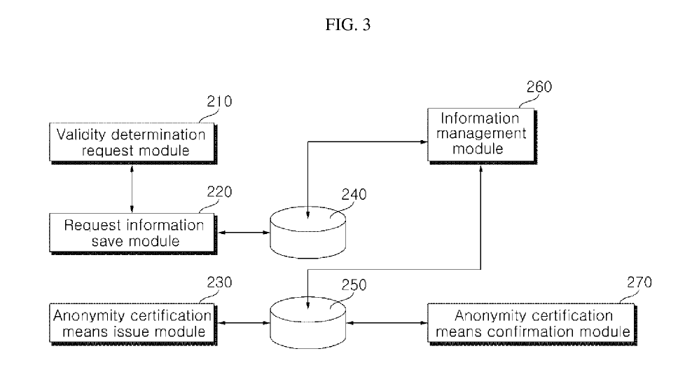

FIG. 3 illustrates a block diagram for an exemplary embodiment of an anonymity process server illustrated at FIG. 1.

Referring to FIG. 3, an anonymity process server 200 includes a validity determination request module 210, a request information save module 220, an anonymity certification means issue module 230, a information management module 260, an anonymity certification means confirmation module 270, a real name certification request database 240, and an anonymity certification means issue database 250.

The anonymity certification means issue module 230 determines validity of a real name certification means provided by a user, when the user provides the real name certification means through the terminal 50. When the real name certification means provided by a user is valid, the anonymity certification means issue module 230 provides an anonymity certification means through the terminal 50.

Also, the anonymity certification means issue module 230 saves the anonymity certification means issued to a user and information thereof in the anonymity certification means issue database 250, after issuing the anonymity certification means to the user through the terminal 50.

The validity determination request module 210 determines validity of the real name certification which the user provides in order to issue the anonymity certification means.

The validity determination request module 210 transmits the real name certification means provided by the user to the real name process server 100 and requests determination of validity for the real name certification means, when the user requests issue of the anonymity certification means through the terminal 50. When the real name certification means provided by the user is not valid, issuing process of the anonymity certification means for the user is finished. The request information save module 220 matches information of the real certification means provided by the user with information of the user and saves the matched information in the real name certification request database 240, when the user requests issue of the anonymity certification means.

The anonymity certification means confirmation module 270 confirms an anonymity certification means of the user writing a bulletin on the web service server 400 upon the request of the trace server 300. The anonymity certification means confirmation module 270 determines whether the anonymity certification means of the user is valid based on the anonymity certification means saved in the anonymity certification means issue database 250 and information thereof.

The information management module 260 manages the real name certification request database 240 and the anonymity certification means issue database 250, and may provide interface and program, which a manager may use to access the real name certification request database 240 and the anonymity certification means issue database 250, if necessary.

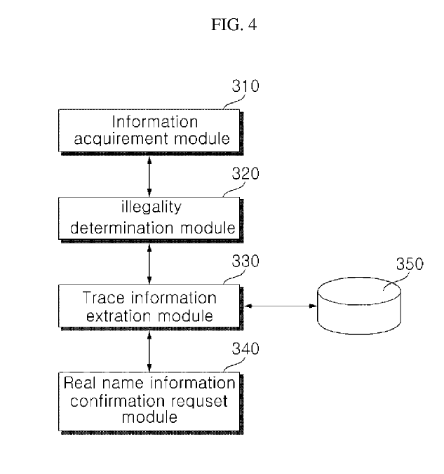

FIG. 4 illustrates a block diagram for an exemplary embodiment of a trace server illustrated at FIG. 1.

Referring to FIG. 4, the trace server 300 includes an information acquirement module 310, an illegality determination module 320, a trace information extraction module 330, a real name information confirmation request module 340, and database 350.

The information acquirement module 310 acquires information of the user, about whom a real name trace is requested by the web service server 400. The information acquirement module 310 acquires an anonymity certification of the user, IP of the terminal 50 of the user, a bulletin written by the user about whom the trace is requested, and other information necessary for the trace from the web service server 400, and transmits them to the illegality determination module 320.

The illegality determination module 320 may determine illegality by checking the existence of banned word or slang word among words included in the bulletin. The illegality determination module 320 may also determine illegality of the article written in the bulletin after a manager checks the content of the article. If the determination result of the bulletin provided by a web service server 400 turns out to be illegal, the illegality determination module 320 may transmit the bulletin provided by the web service server 400 and the anonymity certification means to the trace information extraction module 330.

The trace information extraction module 330 extracts IP of a user writing the bulletin illegally, an anonymity certification means of the user, and access history of the user and transmits them to the real name information confirmation request module 340. The trace information extraction module 330 may save IP of the user, the anonymity certification means, and the access history of the web service server 400 in database 350.

The real name information confirmation request module 340 acquires the IP of the user writing the bulletin illegally, the anonymity certification means of the user, and the access history of the user through the trace information extraction module 330. The real name information confirmation request module 340 may transmit them to the real name process server 100 and request real name information of the user writing the bulletin illegally.

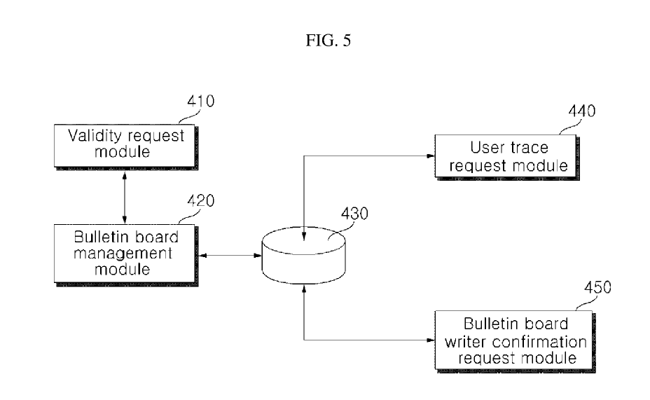

FIG. 5 illustrates a block diagram for an exemplary embodiment of a web service server illustrated at FIG. 1.

Referring to FIG. 5, the web service server 400 includes a validity request module 410, a bulletin board management module 420, a bulletin database 430, a user trace request module 440, and a bulletin board writer confirmation request module 450.

The validity request module 410 transmits the anonymity certification means which a user provides to the web service server 400 through the terminal 50 to the anonymity process server 200 and requests verification for validity of the anonymity certification means. In the present invention, the web service server 400 does not process log-in through ID or password. Rather, the web service server 400 authenticates the user though an anonymity certification means of the user. However, it is possible for the user to log in using conventional ID, password. In the exemplary embodiment, the user may log in using either ID and password or the anonymity certification means.

The web service server 400 does not have any information, based on which the web service server may know the real name of a user accessing the web service server 400 using an anonymity certification means. Therefore, personal information of the user, such as name, address, contact information, resident registration number and etc., is not grasped by the web service server 400, when the user access the web service server 400 through the terminal 50.

The bulletin board management module 420 provides services, by which the user may write, revise, delete, or inspect a bulletin through the terminal 50. When the user writes, revises, or deletes a bulletin, the bulletin board management module 420 reflects the content changed by the user in the bulletin database 430.

If an unwholesome content is included in a bulletin written by the user, the user trace request module 440 requests a real name certification or real name information of the user accessing to the web service server 400 through an anonymity certification means to the trace server 300. The determination of the validity of the bulletin may be achieved automatically or manually.

If the determination of the validity of the bulletin is achieved automatically, the user trace request module 440 determines whether banned word, slang word, or public morals offense word is included among words included in a bulletin and decides whether to request a trace of the anonymity user to the trace server 300.

When the determination of the validity of the determination of the bulletin is achieved manually, the user trace request module 440 may request a trace for an anonymity user whom the bulletin manager nominates to the trace server 300.

The bulletin board writer confirmation request module 450 inquires the anonymity process server 200 through the trace server 300, whether bulletin writers with the same name or ID are identical when there are at least two bulletin writers with the same name or ID. In the present invention, a user accessing the web service server 400 use the anonymity certification means. Therefore, unlike the conventional web service server which allots an ID to a user in the present invention, same ID may exist between two different users.

If the bulletin writers have the same name (ID), identity of the writers must be determined. Hence the bulletin board writer confirmation request module 450 may transmit anonymity certification means for the writers with the same name (ID) to the anonymity process server 200 through the trace server 300. Also, the bulletin board writher confirmation request module 450 may transmit IP of the writers with the same name (ID) or access history of the writers with the same name (ID) to the web service server 400 to the trace server 300. This is to inquire whether the writers with the same name (ID) are identical.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. Conditionally traceable anonymous service system, comprising:
a real name process server generating a real name certification means for a user;
an anonymity process server generating a anonymity certification means corresponding to the real name certification means; and
a trace server requesting a real name certification for the anonymity certification means to the anonymity process server when a web service server requests a real name certification for the anonymity certification means;
wherein the anonymity process server certifies the anonymity certification means when the trace server requests the real name certification for the anonymity certification means and provides the certified anonymity certification means to the real name process server,
and wherein the real name process server performs a real name certification for the certified anonymity certification means,
so that an authority for anonymity confirmation, real name confirmation, and trace request is separated.

2. The system of claim 1, wherein the web service server transmits an anonymity certification means provided by the user to the anonymity process server and determines web service permission for the user according to the result of certification provided by the anonymity process server upon the transmission.

3. The system of claim 1, wherein the real name process server comprises:
a database which includes the real name certification means and personal information for the user;
a module for issuing a real name certification means, which generates a real name certification means corresponding to personal information provided by the user through a terminal; and
a module for confirming a real name certification means, which looks up a real name certification means corresponding to the anonymity certification means with reference to the database when a real name certification for the user is requested by the anonymity process server and confirms the user.

4. The system of claim 1, wherein the anonymity process server comprises:
a module for issuing a anonymity certification means, which generates a anonymity certification means corresponding to a real name certification means provided by the user;
a database which includes information of the real name certification means and the anonymity certification means linked to the information of the real name certification means; and
a module for confirming an anonymity certification means, which confirms the validity for the anonymity certification means when the confirmation of an anonymity certification means for the user is requested by the web service server.

5. The system of claim 1, wherein the trace server comprises:
a module for acquiring information, which receives a confirmation request for the anonymity certification means from the web service server;
a module for determining illegality, which determines illegality of the anonymity certification means corresponding to the confirmation request received;
a module for extracting trace information, which generates trace information for the anonymity certification means; and
a module for requesting confirmation of a real name information, which transmits the trace information to the anonymity process server.

6. The system of claim 1, wherein the real name certification means is a real name certificate or one time password,
and wherein the anonymity certification means is an anonymity certificate or a group member key.

7. The system of claim 1, wherein the web service server inquires to the trace server, whether bulletin writers with the same name are identical.
